(19) United States
(12) Patent Application Publication
(10) Pub. No.: US 2026/0290026 A1
(43) Pub. Date: Sep. 24, 2026

(54) DISTRIBUTED WORKLOADS, AND ASSOCIATED UNITS, SYSTEMS, METHODS, AND DEVICES

(71) Applicant: LiveView Technologies, LLC, American Fork, UT (US)

(72) Inventors: Previn R. Menon, Spanish Fork, UT (US); Thierry Yuen-Lusetti, Sandy, UT (US); Michael N. Abbott, American Fork, UT (US); James P. Bangerter, Saratoga Springs, UT (US); Chintankumar R. Patel, Kirkland, WA (US); Kevin Brinkerhoff, Provo, UT (US)

(21) Appl. No.: 19/576,278

(22) Filed: Mar. 24, 2026

Related U.S. Application Data
(60) Provisional application No. 63/776,794, filed on Mar. 24, 2025.

(51) Int. Cl. G06V 20/52; G06V 10/56; G06V 10/94; G06V 40/10; G08B 7/06; H04N 7/18; G06V 10/96; G08B 13/196

(52) U.S. Cl. CPC G06V 20/52; G06V 10/56; G06V 10/95; G06V 40/10; G08B 7/06; H04N 7/183; G06V 10/96; G08B 13/19613

(57) ABSTRACT

Surveillance systems configured to utilize distributed analytics provide object recognition, threat detection, and identification of selected characteristics of the object. A system includes a mobile unit having at least one image capture device and a processor. The mobile unit includes at least one edge computing device. The mobile unit is in electronic communication with a server via a metered network. Each of the at least one camera, the camera processor, the edge computing device, and the server are configured to perform at least one analytic on image data captured via the mobile unit. A method for surveillance includes detecting an object via a camera of a mobile unit, detecting an action associated with the object via an edge computing device of the mobile unit; and detecting at least one characteristic associated with at least one of the object or the action via a server communicatively coupled to the mobile unit.

### CROSS-REFERENCE TO RELATED APPLICATIONS

This application claims priority to U.S. Provisional Patent Application No. 63/776,794 filed on 24 Mar. 2025, the disclosure of which is incorporated herein in its entirety by this reference.

### TECHNICAL FIELD

This disclosure relates generally to distributed workloads, and more specifically to distributing compute/analytic models across multiple devices, and to related units, systems, methods, and devices.

### BACKGROUND

A network may include an edge device, which may process data locally near a data source with minimal latency, while a cloud device may be a centralized device (e.g., a server) for processing data on a larger scale. Cloud devices typically have greater processing power compared to edge devices; however, unlike edge devices, cloud devices may suffer from latency issues due to being positioned remote from a data source.

### SUMMARY

Embodiments of this disclosure relate to systems, methods, and computer program products for performing surveillance including detecting objects with a camera of a surveillance unit, identifying object actions with an edge computing device of the surveillance unit, and detecting one or more characteristics of the at least one object with a server in communication with the surveillance unit.

In an embodiment, a method for mobile surveillance is disclosed. The method includes detecting at least one object via at least one camera of a mobile surveillance unit. The method includes identifying at least one action associated with the at least one object via an edge device of the mobile surveillance unit. The method includes instructing a server operably coupled to the mobile surveillance unit via a metered connection to detect at least one characteristic associated with one or more of the at least one object or the at least one action and to communicate the at least one characteristic with the mobile surveillance unit. The method includes, responsive to detecting the at least one characteristic, performing one or more of tracking the at least one object with the at least one camera, providing a deterrence output from the mobile surveillance unit, or notifying a command center in communication with the mobile surveillance unit of the at least one characteristic.

In an embodiment, system for mobile surveillance is disclosed. The system includes a mobile surveillance unit including at least one image capture device and an edge computing device. The system includes one or more processors. The system includes memory in electronic communication with the one or more processors. The system includes instructions stored in the memory, the instructions being executable by the one or more processors to capture, by the at least one image capture device, a plurality of images depicting at least a portion of a field of view at a site of the mobile surveillance unit. The instructions of the system include instructions to detect at least one object in the field of view via the at least one image capture device. The instructions of the system include instructions to identify at least one action associated with the at least one object via the one or more processors associated with the edge computing device. The instructions of the system include instructions to instruct a server operably coupled to the mobile surveillance unit via a metered connection to detect at least one characteristic associated with one or more of the at least one object or the at least one action and to communicate the at least one characteristic with the one or more processors. The instructions of the system include instructions to, responsive to detecting the at least one characteristic, perform one or more of tracking the at least one object with the at least one image capture device, providing a deterrence output from the mobile surveillance unit, or notifying a command center in communication with the one or more processors of the at least one characteristic.

In an embodiment, a non-transitory computer readable storage medium storing instructions thereon is disclosed. The instructions include instructions that when executed by at least one processor, causes a computing device to perform operations. The instructions include instructions to obtain a plurality of images depicting at least a portion of a field of view at a site of a mobile surveillance unit. The instructions include instructions to detect at least one object in the field of view in the plurality of images via at least one image capture device. The instructions include instructions to identify at least one action associated with the at least one object via an edge computing device. The instructions include instructions to instruct a server operably coupled to the mobile surveillance unit via a metered connection to detect at least one characteristic associated with one or more of the at least one object or the at least one action and to communicate the at least one characteristic with the at least one processor. The instructions include instructions to detect the at least one characteristic, perform one or more of tracking the at least one object with the at least one image capture device, providing a deterrence output from the mobile surveillance unit, or notifying a command center in communication with the at least one processor of the at least one characteristic.

### BRIEF DESCRIPTION OF THE DRAWINGS

FIG. 1 is a schematic of a system for surveillance, according to at least one embodiment.

FIG. 2 is a perspective view of a system for surveillance including a mobile surveillance unit, according to at least one embodiment.

FIG. 3A is a schematic diagram of a compute overview, according to at least one embodiment.

FIG. 3B is a block diagram of an object detection and alert system, according to at least one embodiment.

FIG. 4 is a block diagram of an algorithm for surveillance, according to at least one embodiment.

FIG. 5 is a block diagram of an algorithm for analysis of a plurality of images captured by a surveillance unit, according to at least one embodiment.

FIG. 6 is a schematic diagram of a system for surveillance, according to at least one embodiment.

FIG. 7 is a flowchart of a method for mobile surveillance, according to at least one embodiment.

FIG. 8 is a block diagram of a computer system, according to at least one embodiment.

### DETAILED DESCRIPTION

Embodiments disclosed herein relate to distributing analytic tasks for increased performance in surveillance devices, systems, methods, and applications such as a mobile surveillance application including one or more mobile surveillance units. A system or method for mobile surveillance includes a mobile surveillance unit having at least one image capture device, an edge computing device, and a connection to a remote server. The mobile surveillance unit includes one or more processors and memory in electronic communication with the one or more processors. The mobile surveillance unit includes instructions stored in the memory which are executable by the one or more processors to detect an object via the at least one image capture device, detect at action associated with the object via an edge computing device, and to instruct a server operatively coupled to the mobile surveillance unit to detect at least one characteristic associated with at least one of the object or the action. The distributed analyses performed in the at least one image capture device, the edge computing device, and the server provide for faster identification of objects, identification of actions of the objects, and identification of characteristics of the objects than in undistributed analytical regimes. Lower latency, lower power usage, and lower outside computation costs are also achieved by the distributed workloads for analytical tasks disclosed herein.

Advancements in camera technology and cloud computing have enabled real-time and large-scale image analytics. Traditional camera-based analytics systems rely on local computing resources, which may have limitations in processing power and scalability. However, relying solely on cloud-based analytics may result in increased data transfer costs and latency issues.

Various embodiments may relate to multipoint AI compute model. Cloud and multi-edge (e.g., camera and additional hardware/processor) component approach may improve performance and cost by assigning tasks based on complexity and latency requirements. By intelligently distributing the workloads, latency for critical events may be reduced, device costs and power consumption may be reduced, and accuracy may be increased, thus providing a competitive advantage in the market.

In some embodiments, some analytics may be performed in the cloud (e.g., cloud-based analytics), typically in a datacenter with high power and computing capabilities.

Some use cases (state based analytics) may include single frames or low frame rate applications (e.g., <1 frame per second) and/or when coordination across multiple locations/sites is desired and/or comparison of historical information. The single pictures, single frames of a video, or the like may be referred to herein as “images,” with videos and multiple pictures or frames of a sequence of images being referred to as “video(s)” or “a plurality of images.” Use cases may include when verification may be desired (e.g., to reduce false positives (e.g., reduce alerts) or augment edge analytics. Various example analytics performed on the cloud may include, for example only, crowd detection, laying down detection, hot list, characteristics detection (e.g., for generated AI audio response), animal false alarm detection, tracking a single person or car across multiple cameras on the same site, without limitation.

In some embodiments, some analytics may be performed via an edge device (e.g., edge analytics; “advanced edge”) (e.g., of a unit (e.g., mobile surveillance unit)). Edge analytics may run on dedicated hardware on the edge and is cloud-connected (e.g., via ISP). The hardware (e.g., processor) may include greater higher computing power than is typical for just an onboard camera processor. In some embodiments, the hardware may include an Nvidia Jeston based solution.

One use case may include an advanced action based analytics that require real time (low latency) multi-frame rate (e.g., 5 frames per second or greater). Another use case may include analytics tied to a local deterrence that may require high availability when there may not be a stable cloud connection. Yet another use case may include reducing the payload size of camera analytics, including cropping to increase the speed of the round trip latency to the cloud.

It is noted that, in some examples, if more basic real-time camera analytics models (intrusion & loitering) are developed to run on an edge device, it may require a small portion of the overall compute budget (e.g., no greater than 35%) to leave room to layer on more advanced options solutions. This may provide flexibility and independence from camera vendors.

Various example analytics performed on the cloud may include, for example only, running detection, riots, weapons detection, license plate recognition (LPR), multiple camera coordination (Pano + PTZ), image cropping (e.g., for generated AI audio response, crowd detection, or local text to speech).

In some embodiments, some analytics may be performed via one or more cameras (e.g., of a unit (e.g., mobile surveillance unit)) (e.g., PTZ, Bullet, and Multispectral). In these embodiments, a co-processor or co-located analytics processing on the camera itself may exist. IP connected to the cloud via cellular or edge computing device via ethernet. Some use cases may include simple action based analytics with low latency and in real time. some use cases may include a dedicated camera with onboard analytics for particular implementations or high-priority solutions that are not large in computational resources but can generally take care of most or all of the computing budget for the hardware. Various example analytics performed on a camera may include, for example only, loitering, intrusion detection, basic shape detection (e.g., car, person, animal), LPR, and high temperature detection.

As will be appreciated, various embodiments disclosed herein may increase accuracy, may reduce latency and response time to act, and/or may reduce cost and power consumption of end devices (i.e., by offloading when necessary).

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and various embodiments may be applicable to other systems and devices, such as stationary units (e.g., a unit coupled to a stationary pole (e.g., a light pole), a structure (e.g., of a business or a residence), a tree, etc.). Embodiments of the disclosure will now be explained with reference to the accompanying drawings.

Referring in general to the accompanying drawings, various embodiments of the disclosure are illustrated to show example embodiments related to distributed workloads. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

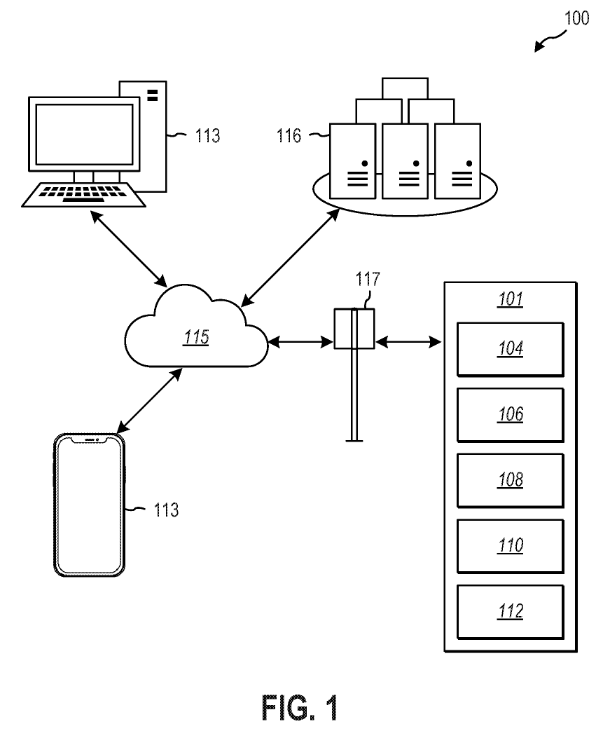

FIG. 1 is a schematic of a system 100 for surveillance, according to at least one embodiment. System 100, which may include a security and/or surveillance system, includes a unit 101, which may also be referred to herein as a “mobile unit,” a “mobile security unit,” a “mobile surveillance unit,” a “physical unit,” or some variation thereof. According to various embodiments, unit 101 may include one or more sensors 104 (e.g., cameras, weather sensors, motion sensors, noise sensors, chemical sensors, without limitation) and one or more output devices 106 (e.g., lights, speakers, electronic displays, without limitation). In some embodiments, the one or more sensors 104 may include at least one image capture devices (e.g., one or more cameras), such as thermal cameras, infrared cameras, optical cameras, pan-tilt-zoom (PTZ) cameras, bi-spectrum cameras, any other camera, or any combination thereof. The unit 101 may be configured to perform one or more analytic tasks, such as object detection, objection action detection, or the like. In some embodiments, one or more cameras of unit 101 may include analytic capabilities such as having a processor and memory storage with machine readable and executable instructions to perform one or more analytical tasks, at least one edge computing device, or the like. For example, sensors 104 may include one or more cameras made by Axis Communications AB of Lund, Sweden, Bosch Security Systems, Inc. of New York, USA, and other camera manufacturers.

The one or more output devices 106 may include one or more lights (e.g., flood lights, strobe lights (e.g., LED strobe lights), and/or other lights), one or more speakers (e.g., loudspeakers, two-way public address (PA) speaker systems, or any other suitable speaker), any other suitable output device (e.g., a digital display), or any combination thereof.

In some embodiments, unit 101 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, RF sensors, environmental sensors, acoustic sensors, without limitation) of unit 101 (e.g., 24 hours a day, 7 days a week, or any other time scenario). Storage device 108 may be configured to store and catalogue images, videos, or portions thereof by reference labels. The reference labels may include alphanumeric reference characters. The reference labels may be assigned based on one or more of date, time, location, object type, object action, or the like. The reference labels may be assigned by the storage device 108 or computer 110.

Unit 101 may further include a computer 110, which may include a non-transitory memory storage medium and at least one processor in electronic communication with the memory. The at least one processor may include any processor, controller, logic, and/or other processor-based device configured to read and execute machine readable and executable instructions stored in the memory. Computer 110 may include an operating system (e.g., installed on the memory such as a hard drive). According to various embodiments, computer 110 may include various analytic and/or compute capabilities, including various AI models. The computer 110 may include and/or may be coupled to one or more (e.g., a platform of) AI computing modules/AI-powered applications.

In some embodiments, unit 101 may include one or more additional devices including, but not limited to, one or more microphones, one or more solar panels, one or more power generators (e.g., fuel cell generators), or any combination thereof. Unit 101 may also include a communication device 112, which may comprise any suitable and known communication device (e.g., a modem (e.g., a cellular modem, a satellite modem, a Wi-Fi modem, etc.)). In some embodiments, communication device 112 may include one or more radios and/or one or more antennas. As will be appreciated, components of unit 101 may be suitably coupled via wired connections, wireless connections, or a combination thereof.

System 100 may further include one or more remote (electronic) devices 113, which may comprise, for example only, a mobile device (e.g., mobile phone, tablet, etc.), a laptop computer, a desktop computer, or any other suitable electronic device (e.g., a user device) including a display. Remote device 113 may be accessible to one or more end-users. Additionally, system 100 may include at least one server 116 (e.g., a cloud server), which may be remote from unit 101. According to various embodiments, server(s) 116, which may include analytic capabilities, may include various models (e.g., AI models). For example, the server(s) 116 may include machine readable and executable instructions to perform one or more of object detection, action (of the object) detection, object characteristic detection, communication with the unit 101 or any other acts disclosed herein. The servers 116 may include one or more processors configured to read and execute machine readable instructions stored on the (memory of) server(s) 116.

Communication device 112, remote devices 113, and server(s) 116 may be coupled to one another via the Internet 115 (e.g., via a Wi-Fi, cellular, and/or satellite connection), a cloud network, or the like. According to various embodiments of the disclosure, unit 101 may be within a first location (a “camera location” or a “unit location”), and server 116 may be within a second location, remote from the first location. In addition, each remote device 113 may or may not be remote from unit 101 and/or server 116. The system 100 may be modular, expandable, and/or scalable.

The system 100 and unit 101 are configured to monitor an area of interest to determine the presence of an object in the area of interest, determine one or more actions of the object, determine one or more characteristics of the object (e.g., identifying characteristics), and provide feedback to one or more of the object in the area of interest or a user interface of the remote device(s) 113 (e.g., electronic devices) as disclosed in more detail below.

The unit 101 is configured to capture images of an area of interest, detect at least one object in the images via the at least one sensor 104 (e.g., camera). The unit 101 is configured to identify at least one action associated with the at least one object via an edge computing device of the unit 101, instruct a server 116 operably coupled to the unit 101 via a metered connection to detect at least one characteristic associated with one or more of the at least one object or the at least one action and to communicate the at least one characteristic with the unit 101. The unit 101 is configured to, responsive to detecting the at least one characteristic, perform one or more of tracking the object with the at least one sensor, provide a deterrence output from the unit 101, or notifying one or more remote devices 113 (e.g., a mobile computing device or an electronic command center) in communication with the unit 101 of the at least one characteristic. Such embodiments provide a distributed workload amongst the computing components of the system 100 and provide for faster processing times for analytical tasks, reduced computation load in on-board computing devices in the unit 101, and lower power usage in the unit 101 compared to systems without distributed analytical workloads. In some embodiments, the unit 101 is configured to generate cropped portions of the plurality of images, the cropped portion including the at least one object therein and to instruct the server(s) 116 to detect at least one characteristic associated with one or more of the at least one object or the at least one action in the cropped portions and to communicate the at least one characteristic with the unit 101 (e.g., with the one or more processors or memory of the unit 101). Such embodiments provide yet faster processing of analytical tasks, and lower power usage than units non-distributed analytical workloads.

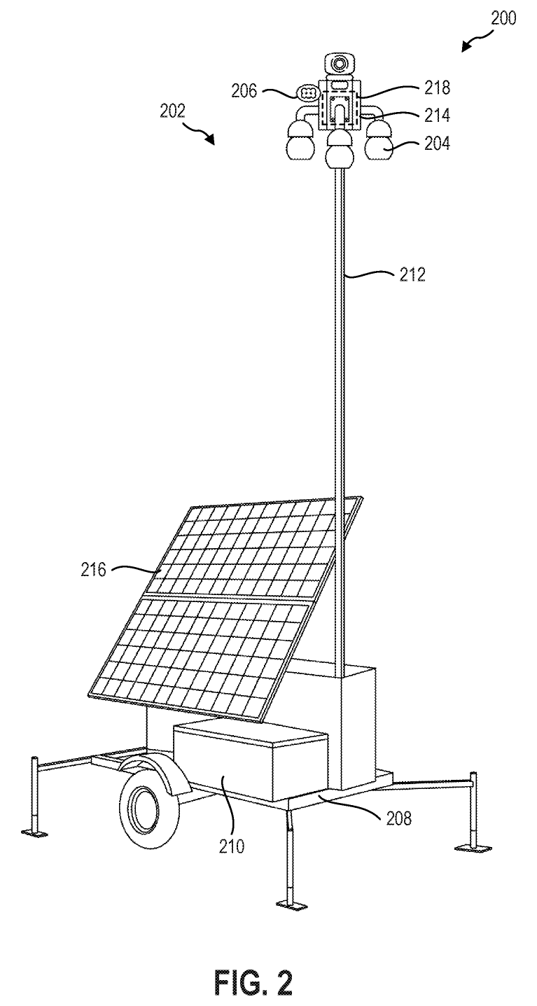

As noted above, in some embodiments, unit 101 may include a mobile unit (e.g., a mobile security/surveillance unit). FIG. 2 is a perspective view of a system 200 including a mobile surveillance unit 202, according to at least one embodiment. The system 200 and unit 202 may be similar or identical to the system 100 and unit 101, in one or more aspects. The unit 202 may include a portable trailer 208, a storage box (e.g., including one or more batteries) 210, a mast 212, and a head unit 214 coupled to the mast 212. The head unit 214 may include one or more sensors 204 (e.g., image capture devices such as cameras), one or more output devices 206 (e.g., lights, one or more speakers, or one or more microphones), and one or more edge computing devices.

Mobile surveillance unit 202 may also be referred to herein as a “mobile unit,” a “mobile security unit,” a “unit,” or a “physical unit.” The unit 202 may be similar or identical the unit 101 in one or more aspects. For example, the unit 202 may include at least one image capture device and an edge computing device. The mobile surveillance unit 202 may be configured to be positioned in an environment or site (e.g., a parking lot, a roadside location, a construction zone, a concert venue, a sporting venue, a school campus, without limitation) to detect objects and their actions in the environment or site. The unit 202 may include one or more sensors 204 (e.g., image captures devices, such as cameras; weather sensors; motion sensors; noise sensors) and one or more output devices 206 (e.g., lights, speakers, electronic displays, or the like). Unit 202 may also include at least one memory storage device including a non-transitory memory storage medium (e.g., internal flash media, a network attached storage device, or any other suitable electronic storage device), which may be configured for receiving and storing data (e.g., video, images, audio, without limitation) captured by one or more sensors 204 of unit 202. The unit 202 may include one or more processors operably coupled to the at least one storage device. For example, the unit 202 may include a computer or computing device having a processor configured to access the memory storage device and to execute machine readable executable instructions thereon. The unit 202 may include a portable trailer 208, a storage box 210, a mast 212, and a head unit 214 coupled to the mast 212. The head unit 214 may also be referred to herein as a “ “edge device,” or simply an “edge”, which may include (or be coupled to) for example, one or more batteries, one or more image capture devices (e.g., cameras), one or more lights, one or more speakers, one or more microphones, and/or other input and/or output devices 206. As used herein, an “edge device” may include at least some of the hardware of an “edge computing device.” The edge device may include task specific hardware (e.g., an image capture device) and processing components. Accordingly, an “edge device” may be used to perform one or more tasks, such as image gathering as well as edge computing tasks.

The mast 212 may be connected to and extending upward from the portable trailer 208, the mast 212 supporting the head unit 214 at an upper region of the mast 212. According to some embodiments, a first end of mast 212 may be proximate storage box 210 and a second, opposite end of mast 212 may be proximate, and possibly adjacent, head unit 214. More specifically, in some embodiments, head unit 214 may be coupled to mast 212 at an end opposite an end of mast 212 proximate storage box 210. In some embodiments, the mast 212 is extendable and retractable.

The head unit 214 may include one or more sensors 204, one or more output devices 206, and one or more edge computing devices 218. The one or more sensors 204 may be similar or identical to the one or more sensors 104, in one or mor aspects. The one or more output devices 206 may be similar or identical to the one or more output devices 106, in one or more aspects. The edge computing device 218 may include one or more processors and/or one or more memory storage devices (memory). For example, the head unit 214 may include one or more processors and memory in electronic communication with the one or more processors, such as any of the memory storage mediums disclosed herein. The edge computing device 218 may be a stand-alone device in the head unit 214 (e.g., processor and memory) or may include components of one or more devices in the head unit 214 (e.g., one or more sensors 204, a computing device, output device). The memory may include instructions for carrying out any of the acts, methods, or processes disclosed herein. For example, the memory may include instructions stored therein, the instructions being executable by the one or more processors to capture, by the at least one image capture device, a plurality of images depicting at least a portion of a field of view at a site of the mobile surveillance unit; detect at least one object in the field of view via the at least one image capture device; identify at least one action associated with the at least one object via the one or more processors associated with the edge computing device; instruct a server operably coupled to the mobile surveillance unit via a metered connection to detect at least one characteristic associated with one or more of the at least one object or the at least one action and to communicate the at least one characteristic with the one or more processors; and responsive to detecting the at least one characteristic, perform one or more of tracking the object with the at least one image capture device, providing a deterrence output from the mobile surveillance unit, or notifying a command center in communication with the one or more processors of the at least one characteristic. In some embodiments, the memory may include a distributed memory including memory storage mediums local to the unit 202 (e.g., on-board processor of a camera or edge computing device 218), remote from the unit 202 (e.g., cloud servers), or both. Likewise, the one or more processors may be local, remote, or both. Accordingly, the head unit 214 may act as, or form at least part of, a local computing device (e.g., within the camera), an edge computing device, a remote computing device, a network connection to a remote computing device, or the like.

The one or more sensors 204 may be similar or identical to the one or more sensors 104, in one or more aspects. The at least one sensor 204 (e.g., image capture device such as a camera) may be configured to perform object detection on a plurality of images and convey the plurality of images and presence of the object therein to the edge computing device 218. For example, the at least one sensor 204 may include a processor configured to perform object detection on the plurality of images (e.g., still frames, videos, or the like). The edge computing device 218 may be configured to perform action detection on the object in the plurality of images and convey a determined action and the plurality of images to a server in communication with the unit 202. In such examples, the server may be configured to perform characteristic detection on the object in the plurality of images and convey one or more detected characteristics to the one or more processors of the unit 202.

The at least one output device 206 may be similar or identical to the at least one output device 106, in one or more aspects.

In some embodiments, unit 202 may include one or more primary batteries (e.g., within storage box 210) and one or more secondary batteries (e.g., within head unit 214). In these embodiments, a primary battery positioned in storage box 210 may be coupled to a load and/or a secondary battery positioned within head unit 214 via, for example, a cord reel. The cord reel may be internally threaded through the mast 212 or on externally an outer surface of the mast 212.

In some embodiments, unit 202 may also include one or more solar panels 216, which may provide power to one or more batteries of unit 202. More specifically, according to some embodiments, one or more solar panels 216 may provide power to a primary battery within storage box 210. Although not illustrated in FIG. 2, unit 202 may include one or more other power sources, such as one or more generators (e.g., fuel cell generators) in addition to or instead of solar panels 216. The unit 202 may include one or controllers/processors (e.g., within head unit 214) configured to control the unit 202 or components thereof.

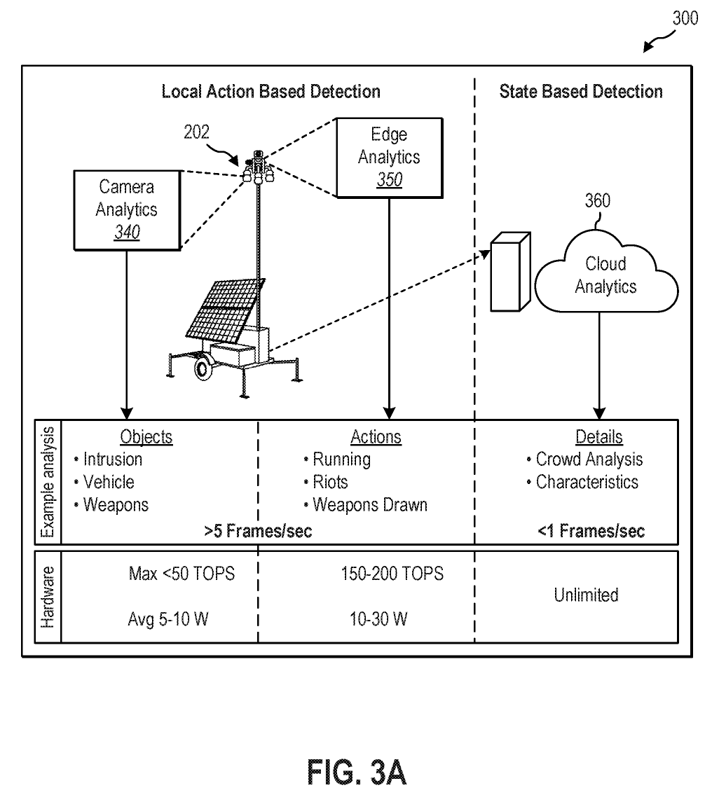

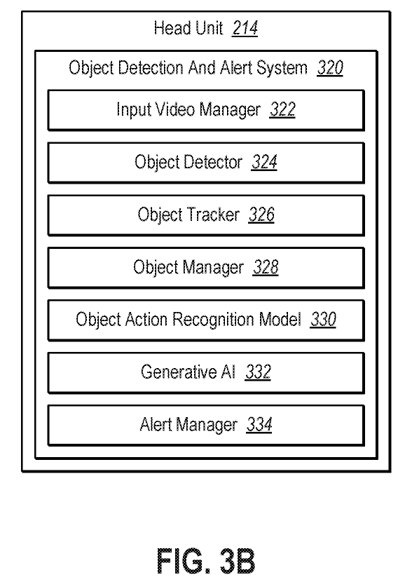

FIG. 3A is a schematic diagram of a compute overview 300, according to at least one embodiment. As depicted in FIG. 3A, analytics may be performed via a camera (e.g., on a mobile unit), via an edge computing device (e.g., edge processor/controller), and via a cloud device. The one or more cameras on the unit 202 may be used to perform camera analytics 340 to detect and identify events, actions of the objects, objects, or the like such as an intrusion into a selected area, loitering, an object (e.g., vehicle or human) in at least one of a plurality of images. The edge device(s) may be used to perform edge analytics 450 to detect and identify events, actions of the objects, objects (e.g., running, walking, lying down, a riot, an object (e.g., a weapon). The cloud device may be used to perform cloud analytics 360 to detect and identify at least one characteristic (e.g., attributes) associated with one or more of the at least one object or the at least one action, events, actions of the object, objects (e.g., crowd formation, description of actions of the objects, description of clothing, description of person, description of items held by the object, or the like).

The at least one camera of the unit 202 may be used for obtaining image data including a plurality of images, the plurality of images depicting at least a portion of a field of view of a site of the unit 202. The camera analytics 340 may include detecting at least one object via at least one camera of a unit. The at least one object may include a human, an animal, an automobile, or the like. The camera analytics 340 may have a power usage of 1 to 10 Watts (W) and a performance of up to about 50 trillion operations per second (TOPS). Such analytics have relatively low power usage and relatively fast latency times (e.g., faster than edge analytics or cloud analytics).

The edge analytics 350 may include identifying at least one action associated with the at least one object via the edge device of the unit. The at least one action may include one or more of standing, walking, running, laying down, vandalism, unauthorized access to a site of the mobile surveillance unit, rioting, fighting, weapon possession (e.g., weapon brandishing or use), or the like. The edge analytics 350 may have a power usage of less than about 30 W (e.g., 10 to 30 W), and a performance of up to about 250 TOPS (e.g., 150 to 200 TOPS). Such analytics have relatively moderate power usage and relatively fast latency times (e.g., faster than cloud analytics). The hardware used to perform the edge analytics 360 may be located in the head unit, the storage box, or both.

The cloud analytics 360 may include instructing a server operably coupled to the head unit via 212 a metered connection (e.g., Wi-Fi, internet provider, upload portal) to detect at least one characteristic associated with one or more of the at least one object or the at least one action and to communicate the at least one characteristic with the unit. The at least one characteristic includes one or more of an item of clothing worn by the human, a color of the clothing, spatial orientation of the human, identity of an object carried by the human, presence or use of a weapon carried by the human, skin color of the human, height of the human, or gender of the human, or the like. The at least one characteristic may be selected to provide one or more identifiable attributes of the object (e.g., human, car) for documentation to a user, the police, or the like. The cloud analytics 360 may have a max power usage that is unlimited, and processing performance (e.g., TOPS) that is substantially unlimited. Such cloud analytics have relatively high power usage and very little latency (ignoring any upload and download time from and to the unit 202). Accordingly, such tasks may be performed with more images (e.g., higher frames per second) than other tasks or in parallel for a plurality of objects (e.g., crowd characteristics identifications) or videos. A limiting factor for cloud analytics 360 may be latency of uploading the images and associated analysis instructions and downloading the results of the cloud analytics, such as for deterrence operations. Such latency may be due to network (e.g., Wi-Fi) signal strength. Other limiting factors for cloud analytics 360 may be budgetary due to costs associated with cloud computing or data transfers.

By prioritizing and performing certain analytical tasks in the camera, edge device(s), and cloud, the analytical tasks can be performed substantially contemporaneously in the various pieces of system best suited to handle the computation load of the tasks. For example, the camera analytics may be very simple and use only low compute power (e.g., electrical power and computational hardware), while the edge analytics perform more sophisticated analyses and use more compute power than the camera analytics, and the cloud analytics perform the most complicated analyses using more compute power than either the edge analytics or the camera analytics. By reducing the amount of analytical tasks sent to the cloud analytics, costs of cloud computing may be saved without sacrificing latency because the simpler tasks (e.g., camera and edge analytics) are carried out by hardware of the unit 202 on site. Accordingly, in some embodiments, only tasks that would result in high latency if run on the onsite hardware (e.g., edge computing device and camera) are performed on the cloud. Such task related routing may be carried out according to any of the workflows disclosed herein, with dedicated hardware being used for each task as assigned by a machine readable and executable program.

FIG. 3B is a block diagram of an object detection and alert system 320, according to at least one embodiment. As shown in FIG. 3B, the object detection and alert system 320 may be at least partially implemented on the head unit 214 of a surveillance unit (e.g., 100 or 200). In one or more embodiments, the object detection and alert system 320 is implemented in whole on the head unit 214 (e.g., as shown in FIG. 2). Other implementations may involve one or more components (e.g., at least some of components 104-112 or 204-214 of FIG. 1 and 2) implemented across different devices and/or units 102 or 202 (FIGS. 1 and 2), or across multiple hardware devices. One or more of such components may rely on data storage of various types of data, this data may be stored within storage and/or memory hardware between one or both of the head unit 214 and storage box 210 (FIG. 2). One or more components of the object detection and alert system 320, including the generative AI model 332, may be implemented on a remote device, such as on a server of a cloud computing system. The generative AI model 332 may include large language model (LLM) trained to perform the functions of one or more of object detection, action detection, or characteristics detection as disclosed herein. The functionality of components of the object detection and alert system 320 in connection with capturing, analyzing, and processing digital content in an effort to detect objects, object activities, and object characteristics depicted therein will be described within a single system entity.

As noted above, the object detection and alert system 320 includes a number of components implemented thereon. As shown in FIG. 3B, the object detection and alert system 320 includes an input video manager 322, an object detector 324, an object tracker 326, an object manager 328, an object action recognition model 330, a generative AI model 332, and an alert manager 334. As noted above, while FIG. 3B illustrates an example in which each of the components are implemented as part of a single system (e.g., on a head unit 214), other implementations may include one or more of the components (e.g., the generative AI model 332) being implemented in part or in whole on other devices or systems (e.g., a cloud computing system).

Additional detail will now be discussed in connection with the above-listed components 320-334. The input video manager 322 may perform features related to capturing or otherwise obtaining multi-media content (e.g., a plurality of images) to be analyzed in determining whether an object is present and object actions are present within one or more of the plurality of images (e.g., video frames). In some embodiments, the input video manager 322 obtains a plurality of images such as video content including video frames captured by a unit 101 or 202 (FIGS. 1 and 2) in which the video frames depict at least a portion of a field of view of a site on which the unit is located. In one or more embodiments, the input video manager 322 captures a plurality of images (e.g., video content) using one or more sensors (e.g., cameras). In some embodiments (e.g., where one or more portions of the object detection and alert system 320 are on a cloud computing system), the input video manager 322 receives video content captured by recording devices on location of the mobile surveillance unit.

As shown in FIG. 3B, the object detector 324 may perform features and functionality related to detecting one or more objects depicted within the plurality of images. In some embodiments, the object detector 324 is trained to detect persons or other objects that are depicted within a given image (e.g., video frame). In some embodiments, the object refers to a person that is depicted within the plurality of images (e.g., video frame(s)). The object detector 324 may detect one or more objects within an image (e.g., video frame) in a variety of ways. In some embodiments, the object detector 324 utilizes a machine learning model, neural network model, or other model that is capable of analyzing image content and detecting or otherwise identifying an instance of a particular object depicted therein.

Upon receiving the detected objects on given images of the plurality of images (e.g., video frames), the object tracker 326 may perform tasks related to generating tracked samples of content in the plurality of images such as video content. For example, the object tracker 326 may assign or otherwise associate a unique identifier (e.g., a tracking identifier) with a given object (e.g., detected object). Where a plurality of images include a first image and a second image (e.g., video frame), the object tracker 326 may assign a first unique identifier with an object that appears in the first image. The object tracker 326 may track movement of the object and determine that the same object that appeared in the first image appears in the second image. In such examples, the object tracker 326 may assign the same first identifier to the object in connection with the second image. This process continues given this object being detected on subsequent images of the plurality oof images (e.g., video frames).

This tracking of identifiers to associated objects is beneficial for a number of reasons. For example, rather than associating a new identifier with each detected object across multiple images, and potentially having hundreds or thousands of objects, the object tracker 326 tracks movement of objects between images to determine that one or more objects are the same object. Based on this determination, the object tracker 326 associates a same object identifier across the different images, preventing the object detection and alert system 320 from erroneously detecting a plurality of objects, object actions, object characteristics in connection with a single object instance.

In conjunction with the object tracker 326, the object manager 328 may generate cropped portions of images based on the objects detected within the images. For example, the object manager 328 may generate a cropped portion of a video frame or other image including a select portion of the video frame or other image around a detected object while excluding other portions of the video frame or other image that does not depict the identified object. In some embodiments, the object manager 328 performs this cropping on each video frame of a plurality of video frames to generate any number of tracked samples of video content (or another plurality of images) including cropped portions of a subset of video frames (or other images) within which a tracked object appears. Each cropped portion may be associated with a unique tracking identifier for the object detected therein.

As discussed in further detail below, the object manager 328 may generate any number of cropped portions for each detected object within a set of video frames. In some embodiments, where a single video frame or other image includes multiple detected objects, the object manager 328 may generate multiple cropped portions, each cropped portion corresponding to a different object detected within the single video frame or other image. Thus, the object manager 328 may generate more cropped portions than sampled video frames or other images.

In some embodiments, the object manager 328 crops the video frames in accordance with a portion of the video frame or other image that depicts the object. For example, the object manager 328 may generate a cropped portion based on a number of pixels and proportion of the video frame or other image within which the object appears.

In some embodiments, the object manager 328 selectively identifies one or more cropped portions to feed as an input to the object action recognition model 330 in equipment remote from the head unit 214, such as at least one server of a cloud computing platform or remote computing device. For example, the object manager 328 evaluates a series of images or frames (e.g., over a plurality of images or a range of video frames depicting an object of interest) and determines one or more of the images or frames for selection based on one or more characteristics of the images or frames. In some embodiments, the object manager 328 determines an image or frame based on a size of the object depicted therein (e.g., where the object is bigger within a given image or frame than other images or frames within the range of the plurality of images or video frames). In some embodiments, the object manager 328 selects the frame (or multiple frames) based on metrics of clarity or lighting or other content-based criteria that impacts a quality of an input provided to the object action recognition model 330.

The object action recognition model 330 includes any model or algorithm configured to analyze or otherwise consider an image and generate a prediction or score associated with one or more object action (e.g., indicating whether at least one action associated with the at least one object appears or does not appear therein). As noted above, the object action recognition model 330 may include a lightweight model that is trained on a limited set of object actions. The object action recognition model 330 may be implemented on the same system as the other components of the object detection and alert system 320 (e.g., on the head unit 214). In some embodiments, the object action recognition model 330 is implemented on a server device (e.g., on a cloud computing system). In such examples, the object action recognition model 330 receives the sampled images (e.g., cropped portions of select sampled images) and performs an analysis of the cropped portions to determine whether an object action is depicted within the associated cropped portions of the corresponding images. The object action recognition model 330 then provides an indication of the object action to the object detection and alert system 320 to determine any additional actions related to occurrence of an object action or event.

In one or more embodiments, the object action recognition model 330 is applied to each tracked sample of video content. For example, where a single image (e.g., video frame) includes a single or multiple cropped portions depicting objects therein, the object action recognition model 330 may be applied to each cropped portion of the image. The object action recognition model 330 may be applied to each cropped portion across multiple images to determine whether one or more actions on which the object action recognition model 330 has been trained appears within the respective cropped portion(s).

As noted above, the object action recognition model 330 may be trained to detect whether a given object action appears within the content of an image (e.g., a cropped portion of a video frame). In some embodiments, the object action recognition model 330 includes a model having been trained on a defined set of object actions. In some embodiments, the object action recognition model 330 generates a prediction as to whether an object action (e.g., event) has occurred. In such examples, the object action recognition model 330 may determine that, based on an action being performed by the object (e.g., person) present in the plurality of images would constitute an object action (e.g., selected from a list or training data of actions) that merits elevating image analysis to an object characteristic detection algorithm. In some embodiments, rather than making an object action determination, the object action recognition model 330 may simply determine a score (e.g., an action prediction score) associated with whether the object action is depicted within the image(s). The action prediction score may then be used by another component within the object detection and alert system 320 to determine occurrence of an object action.

As further shown in FIG. 3B, the object detection and alert system 320 includes, or is in remote communication with, a generative AI model 332. The generative AI model 332 may be implemented on a remote device (e.g., a server of a cloud computing system). The object detection and alert system 320 may communicate one or more of a plurality of images of the object (which may include images of the object performing the object action) with the remote device for identification of object characteristics (e.g., clothing type and color, presence of weapons, or the like), such as by the generative AI model 332. In such embodiments, the generative AI model 332 may be implemented on the remote device but be managed at least in part by the object detection and alert system 320. Accordingly, the generative AI model 332 may be at least partially implemented in the head unit 214. By offloading the analysis of object characteristic detection and identification, an analytical task that takes more processing power, equipment, and time on even an edge device, the embodiments herein provide parallel processing of analytical tasks to components configured to perform those tasks in a time frame that provides for faster processing than if all tasks were performed locally in the unit. Further, the embodiments disclosed herein provide for lower costs associated with embodiments that offload all or a larger proportion of analytical tasks to remote computing devices (e.g., lower wireless provider costs and lower processing costs on the remote devices). This parallel processing of images in the image capture device (e.g., object detection, the edge computing device (e.g., objection action detection), and the remote device(s) (e.g., object characteristic detection) provides load leveling to the on-board equipment in the unit 101 or 202.

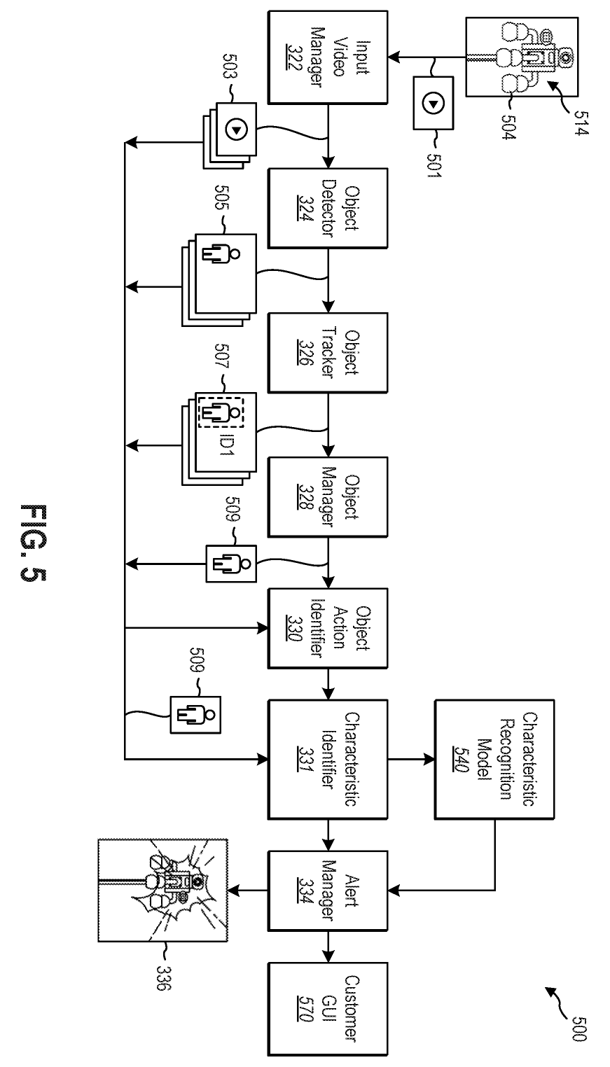

The generative AI model 332 may also be used in cooperation with the object action recognition model 330 to determine whether an object action has occurred based on content of one or more of a plurality of images (e.g., video frames). Additional detail of the generative AI model 332 working in cooperation with the object action recognition model 330 are discussed below (e.g., in connection with FIG. 5).

As shown in FIG. 3B, the alert manager 334 may determine whether an object action has occurred and perform one or more actions based on the object action determinations. For example, the alert manager 334 may receive one or more prediction scores from the object action recognition model 330 and determine, based on the score(s), whether object action is being performed by one or more objects (e.g., persons) depicted in the images and that an object action has therefore occurred. In some embodiments, the alert manager 334 may receive an output from the object action recognition model 330 (or from the generative AI model 332) indicating occurrence of an object action, and characteristics of the object, which the alert manager 334 can process in a number of ways.

In some embodiments, the alert manager 334 generates an alert or causes the unit 101 or 202 to generate an alert. More specifically, based on the prediction score or indication of an object action (an object characteristics, the alert manager 334 may generate an alert associated with one or more persons performing one or more flagged actions (e.g., trespass, unsafe conduct, theft)) at a site of the unit 101 or 202. In some embodiments, generating the alert includes generating an audible announcement to be heard by individuals at the site (e.g., generating an announcement on a speaker of the unit 101 or 202). In some embodiments, the alert manager 334 generates an audible announcement by transmitting (or causing to be transmitted) an electronic communication to at least one client device of a user(s) associated with the mobile surveillance unit 101 or 202. This may involve texting, pinging, sending a push notification, or otherwise communicating occurrence of the action(s) (of the object) and object characteristics to a user of an electronic device (e.g., operator of the remote device(s) 113, or unit 101 or 202). In some embodiments, this may involve broadcasting a signal that is received at any number of client devices (e.g., such that everyone within a vicinity is alerted to the object or action(s) of the object).

Additional detail will now be discussed in connection with example workflows or algorithms showing implementations of the object detection and alert system 320 and methods in accordance with one or more embodiments.

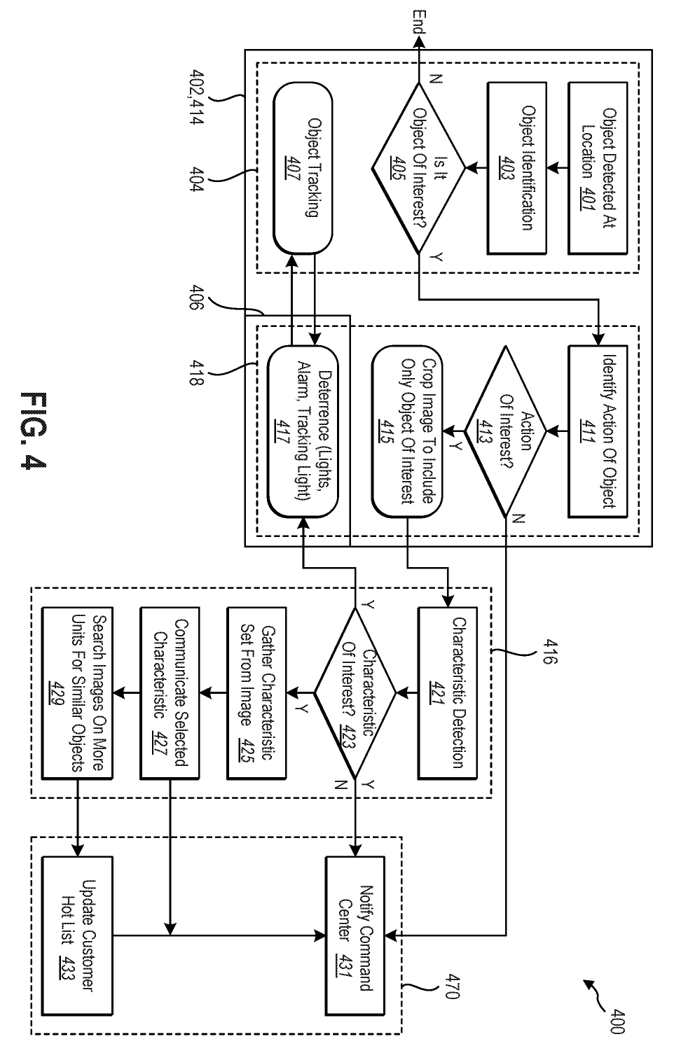

FIG. 4 is a block diagram of an algorithm 400 for surveillance, according to at least one embodiment. The algorithm 400 utilizes at least one camera 404, an edge computing device 418, a cloud computing device 416 (e.g., servers of a cloud), and a graphical user interface (GUI) 470. The algorithm 400 may be implemented on any of the systems or devices disclosed herein. For example, the surveillance unit 402 may be similar or identical to the surveillance unit 202 in one or more aspects, the head unit 414 may be similar or identical to the head unit 214 in one or more aspects, the at least one camera 404 (e.g., video camera) may be similar or identical to the at least one sensor 204 (FIG. 2) in one or more aspects, the edge computing device 418 may be similar or identical to the edge computing device 218 (FIG. 2) in one or more aspects, the cloud computing device 416 may be similar or identical to the at least one server 116 (FIG. 1) of a cloud computing network in one or more aspects.

In the algorithm 400, an intrusion may be detected by detecting at least one object via at least one camera 404 of a mobile surveillance unit 402 at a location at block 401 (e.g., in a field of view of a camera on a unit at the location). The object may be identified at block 403, where it may be determined whether the at least one object is a human, an animal, an automobile, or the like. In some examples, the actions at blocks 401 and 403 may be performed by the at least one camera 404 (e.g., on a surveillance unit, such as a mobile surveillance unit 402). If the object is an object of interest, such as a human or an automobile, the algorithm 400 advances to action identification. If the object is not an object of interest, the algorithm 400 ends (e.g., continues to seek and identify objects at the location).

The algorithm 400 may advance to identifying at least one action associated with the at least one object, such as via an edge computing device 418 (e.g., edge device) of the mobile surveillance unit 402. The edge computing device 418 may be used to identify action(s) of the object according to one or more machine readable and executable instructions stored or received therein.

If it was determined that the detected object is a human, an automobile, or another object of interest (e.g., object identified by a user or instructions as an object that is to be identified), the algorithm 400 proceeds to identifying an action of the object at block 411. For example, if it is determined that the intrusion involved a human, it may be determined what action is being performed by the human(s). Identifying at least one action associated with the at least one object may include identifying the action of the object from the one or more images. The action may include one or more of running, driving, fighting, walking, loitering, standing, lying down, vandalism, violence (e.g., fighting), or the like at the site of the mobile surveillance unit 402. For example, edge computing device 418 (e.g., a processor/controller) on the mobile surveillance unit 402, such as the camera 404 on the head unit 414 may search the one or more images to identify actions of the object in the images such as via a frame-by-frame analysis of the object in the images.

The algorithm 400 may proceed to determining if the detected action is an action of interest (e.g., an action identified by a user or instructions as an action to be flagged or elevated for further analysis such as characteristics detection) at block 413. If the action detected at block 411 is an action of interest, the algorithm 400 proceeds to characteristic detection at block 421. If the action is not an action of interest, the algorithm 400 proceeds to notify a command center that no action of interest is detected but may report the presence of the object, such as via the GUI 470 of user device.

In some embodiments, if the action is in action of interest the algorithm 400 includes cropping the image to show substantially only the object of interest at block 415, such as in sub-images depicting only the cropped portion of the image(s). By cropping the images, the amount of data transferred to the cloud computing device 416 (e.g., servers) may be limited and the data to be analyzed is limited, thereby reducing latency and costs (e.g., for data transfers and analysis to, from, and at the cloud computing device 416).

One or more (cropped) images may be sent to the cloud computing device 416, wherein one or more characteristics of one or more objects in the image may be characterized at block 421. For example, the cloud computing device 416 may identify that the human is wearing a red shirt and black pants, and that the human has a weapon. The algorithm 400 may include instructing a server operably coupled to the mobile surveillance unit via a metered connection to detect at least one characteristic associated with one or more of the at least one object or the at least one action and to communicate the at least one characteristic with the mobile surveillance unit. Such instruction may come from machine readable and executable instructions stored on the edge computing device 418 or elsewhere in the mobile surveillance system.

In some embodiments, the algorithm proceeds to determine if the characteristics are characteristics of interest at block 423. Such a determination may be carried out by comparing the identified characteristics of the object in the image(s) to a list or instructions of characteristics of interest. Such characteristics of interest may be selected and used to provide identifying information about the object (e.g., human). The characteristics of interest may include one or more of an item of clothing worn by the human, a color of the item of clothing worn by the human, an accessory worn by the human, physiological traits of the human (e.g., height, weight, hair, skin color, sex), an object carried by the human (e.g., weapon, tool, container, case), or the like.

If characteristics of interest are not present, the algorithm 400 may proceed to notify the command center at block 431 that no characteristics of interest were identified (e.g., no one has a weapon). The command center may include one or more computing devices (e.g., server(s)) configured to communicate with the GUI 470. The GUI 470 may provide a visual indication of the finding, such as on a remote computing device (e.g., cell phone, computer, or the like).

If at least one of the characteristics of interest are present the algorithm 400 may proceed to gather a set of characteristics from the images (e.g., set of images forming a video) at block 425. The cloud computing device 416 may store or receive machine readable and executable instructions to collect data on the characteristics of interest. For example, at least one characteristic may be identified and added to a list from one or more cropped portions of the images. Such a set or list may include any of the characteristics disclosed herein, such as a sex, race, height, and

The algorithm 400 may proceed to communicate the selected characteristics of the object identified in the images with the command center, such as to be presented on the GUI 470.

If at least one characteristic or action of interest is present, an escalation at block 417 may be directed at block 423, such as when a weapon is identified as being carried by a human object. For example, responsive to detecting the at least one characteristic, the algorithm may include performing one or more of tracking the object with the at least one camera, providing a deterrence output from the mobile surveillance unit, or notifying a command center in communication with the mobile surveillance unit of the at least one characteristic. One or more output devices 406 of the mobile surveillance unit 202 may be used to transmit a deterrence signal to persons around the unit 202. Such deterrence may include one or more of lights (e.g., flashing lights, tracking spotlight), audio output (e.g., sirens or audio talk down), or the like from the output device(s) 406. An escalation may occur wherein a response (e.g., a personalized response based on one or more detected characteristics) may be generated (e.g., at cloud computing device 416 or edge computing device 418) and conveyed via a speaker (e.g., on a surveillance unit, such as a mobile surveillance unit 402). Further, a spotlight and/or a camera (e.g., on the head unit 414 of surveillance unit 402) may be used to track the object at block 407.

In some embodiments, an alert may be generated and displayed (e.g., via GUI 470) at block 431. For example, a detailed description including the set of characteristics of the detected object may be generated (e.g., race, gender, height) at block 425 (e.g., on cloud device 306) and communicated to the GUI at block 427.

In some embodiments, the algorithm 400 includes conducting a search at block 429, such as on stored video (e.g., search video matching description) from the mobile surveillance unit, a database, or additional mobile surveillance units. Escalations (e.g., alerts) may be generated and/or updated based on the at least one characteristic provided in the detailed description and/or results of footage search. In some embodiments, a list (e.g., customer hotlist) may be generated and/or updated - (e.g., based on result of footage search) at block 433.

In some embodiments, the algorithm 400 may not consider whether the object is an object of interest, an action is an action of interest, or a characteristic is a characteristic of interest. In such embodiments, the algorithm 400 may proceed to detect objects, identify actions of the object(s), and determine characteristics of the objects for at least some (e.g., every one) of the objects within a field of view of the unit 402 at a site.

In some examples, one or more of the at least one image capture device, the edge computing device, or the server of the system 100 or 200 is coupled to at least one artificial intelligence (AI) model configured to perform the object detection, the action detection, or the characteristic detection.

Additional detail will now be discussed in connection with example algorithms or workflows showing implementations of systems for surveillance according to at least one embodiment. FIG. 5 is a block diagram of an algorithm 500 for analysis of a plurality of images captured by a surveillance unit, according to at least one embodiment. In particular, FIG. 5 illustrates an example algorithm 500 (e.g., workflow) in which a plurality of images (e.g., video content) are captured and an object detection, action detection, and characteristic detection model is used to evaluate select portions of the plurality of images to determine whether an object, action, and characteristic(s) of the object are depicted within the select portions of the plurality of images.

As shown in FIG. 5, at least one camera 504 captures and provides a plurality of images or video content 501 to input video manager 322. The at least one camera 504 may refer to a sensor or image capture device on a head unit 514 of a surveillance unit. The algorithm 500 may be performed using any of the systems or components disclosed herein. For example, the head unit 514 may be similar or identical to the head unit 214 in one or more aspects, the at least one camera 504 may be similar or identical to the at least one sensor 204 (FIG. 2) in one or more aspects.

In one or more embodiments, the algorithm 500 includes cameras 504 that are each capturing and providing video content to the surveillance system 100 (FIG. 1). For ease in explanation, FIG. 5 illustrates an example of a video capturing device at camera 504 that provides the video content 501 (e.g., plurality of images) to the surveillance system 100 (FIG. 1) for further analysis and processing.

As shown in FIG. 5, the input video manager 322 provides video frames 503 (e.g., plurality of images) to an object detector 324. In some embodiments, the frame rate of the video frames 503 is the same as the framerate of the video content 501 provided to the input video manager 322. In some embodiments, the input video manager 322 reduces a frame rate and generates a plurality of video frames 503 at a reduced frame rate and provides the plurality of video frames 503 to the object detector 324 for further analysis. In some embodiments, the input video manager 322 simply provides the video frames 503 as received (at the same or at a reduced frame rate).

The object detector 324 is applied to the plurality of video frames 503 to determine whether one or more objects appear within the video content of the video frames 503. In some embodiments, the object detector 324 includes a machine learning model, such as a convolutional neural network (CNN); however, other types of models that are configured to or otherwise capable of detecting various objects. In some embodiments, the object detector 324 is specifically trained to identify humans within respective video frames. In some embodiments, the object detector 324 provides a set of images 505 including detected objects and bounding boxes around the detected objects.

As shown in FIG. 5, the set of images 505 are provided to the object tracker 326. As noted above, the object tracker 326 maintains a unique identifier for an object of interest for as long as the object appears within the field of view of the at least one camera 504. For instance, where an individual is assigned a unique identifier, the unique identifier may follow the individual for all video frames over a specific duration of time or for as long as the individual appears within video frames over a range of time. Where the individual passes outside of the field of view, then re-enters the field of view after a period of time, the object tracker 326 may or may not associate the same unique identifier to the individual based on computing and memory capabilities of the surveillance system (100 of FIG. 1). In some embodiments, the object tracker 326 assigns a new unique identifier to the individual after some period of time outside the field of view of the at least one camera 504.

As shown in FIG. 5, the object tracker 326 may identify a tracked portion 507 of the sampled set images 505 (e.g., video frames). The tracked portion 507 may refer to an area of a given video frame around which the object of interest appears. As an individual moves locations and therefore passes across the field of view of a camera 504, the object tracker 326 may indicate a different tracked portion 507 of the video frame(s) that reflects the movement of the individual within the video content.

As shown in FIG. 5, the object tracker 326 provides the video frames having the tracked portions 507 to an object manager 328. Based on the tracked portions 507 of the video frames, the object manager 328 may generate cropped portions 509 of the video frames in which the objects of interest are included while other portions of the video frames are excluded. Where multiple objects are detected within a given video frame, the object manager 328 may generate a cropped portion for each detected object.

As noted above, the size and shape of the cropped portion(s) 509 may differ between embodiments. In some embodiments, the object manager 328 generates cropped portions based on the dimensions of a bounding box around which the object is located within a given video frame.

In some embodiments, the object detector 324, the object tracker 326, and the object manager 328 cooperatively generate tracked samples of video content including the cropped portions of video frames that have unique identifiers associated therewith. For example, in one or more embodiments, the object detector 324, the object tracker 326, and the object manager 328 are implemented as a single component that samples the video frames based on tracked objects or movement detected therein in generating the tracked samples of the video content including the cropped portions that are associated with respective unique identifiers.

In some embodiments, generating a first cropped portion of the video frame includes isolating a portion of a first video frame based on an area around a detected object and resizing the isolated portion of the first video frame to generate a first cropped portion. Similarly, the surveillance system may generate a second cropped portion of the video frame, which may include isolating a different (e.g., non-overlapping or slightly overlapping) portion of the first video frame based on an area around a different detected object and then similarly resizing the isolated portion of the video frame to generate a second cropped portion. In some embodiments, the surveillance system generates the cropped portions from different isolated portions of the same video frame. In one or more embodiments, the surveillance system generates the cropped portions associated with the same or different detected objects across different video frames.

Any of the input video manager 322, the object detector,324, the object tracker 326, or the object manager 328 may be applied on or by the at least one camera 504, the edge computing device, or both.

As shown in FIG. 5, the cropped portion(s) 509 corresponding to the tracked object can be provided as input to the object action recognition model 330 (e.g., object identifier) for further analysis. The object action recognition model 330 may be applied to the cropped portion 310 of the video frame to determine an action associated with the object or whether attributes of an action are depicted within the cropped portion 310 of the video frame. The object action recognition model 330 may be applied on or by the edge computing device on the mobile surveillance unit.

As discussed above, the object action recognition model 330 may be applied to any number of cropped portions of one or more video frames. The object action recognition model 330 (e.g., action identifier) may compare the position(s), attitudes, or other attributes of the object in the video frames to known position(s), attitudes, or other attributes associated with known actions to determine if the object is performing or participating in at least one action. For example, the object action recognition model 330 may be constructed (e.g., include instructions) to compare attributes of the object(s) in the video frames, such as the positions of the arms or legs of the object in the video frames to one or more attributes of know actions, such as arm motions or leg motions of known actions (e.g., running, fighting, stabbing, throwing, standing idle, laying down).

As shown in FIG. 5, the cropped portion(s) 509 corresponding to the tracked object can be provided as input to a characteristic identifier 331 for further analysis. The characteristic identifier 331 may be stored on and/or carried out by a cloud computing device. As discussed above with respect to the object action recognition model 330, the characteristic identifier 331 may be applied to the cropped portion 509 of the video frames to determine the identity or presence of one or more characteristics. The one or more characteristics may include any of the characteristics of an object disclosed herein, such as clothing type, clothing color, sex, skin color, height, weight, hair length, hair color, possession of a weapon, or the like.

In some embodiments, the characteristic identifier 331 may be configured to be applied to the cropped portion(s) 509 of the video frames to determine an attribute prediction score associated with whether one or more characteristics are depicted within the cropped portions 509 of the video frames. For example, a characteristic recognition model 540 may be applied to any number of cropped portions of one or more video frames. The characteristic recognition model 540 may include a generative AI model trained to identify at least one characteristic of an object. Such a generative AI model may include an LLM.

In some embodiments, the characteristic recognition model 540 generates an output prediction indicating whether a specific characteristic of the object is present (e.g., holding a tool or weapon) or characteristic of the object (e.g., approximate height, sex, color of clothing). The characteristic recognition model 540 may determine whether a characteristic is present or what a specific character is based on predictions characteristics across multiple video frames (e.g., across multiple cropped portions 509 of different video frames).

In some embodiments, the characteristic identifier 331 or characteristic recognition model 540 determines the presence of a characteristic based on a combination of multiple characteristic prediction scores for a given object over multiple video frames. For example, scores or a cumulative score above a certain threshold score may be identified as a positive indication of a characteristic.

The characteristic identifier 331 or characteristic recognition model 540 may provide an output indicating whether one or more characteristics are present (e.g., list of characteristics identified), such as to the alert manager 334 or GUI 570. The alert manager 334 may generate an alert to notify one or more individuals or computing devices of the characteristics of the object involved in the detected action. In some embodiments, the alert manager 334 may cause one or more output devices to provide a deterrence at the site of the object. For example, the alert manager 334 may cause one or more output devices of the surveillance unit to generate an alert associated with the object (e.g., person trespassing) that the object at a site of the surveillance unit 101 is performing an action of interest, such as an audio alert (e.g., siren, or audio talk-down) or a visual alert (e.g., strobes, flashing, following with a spotlight).

The alert manager 334 may generate (or cause to be generated) a response to the identification of characteristics (and actions of the object associated therewith) in any of a number of ways. For example, the alert manager 334 may cause the surveillance unit to perform one or more of tracking the object with the at least one camera, providing a deterrence output from the mobile surveillance unit, or notifying a command center in communication with the mobile surveillance unit of the at least one characteristic and the action of the object. In some embodiments, the alert manager 334 may cause the surveillance unit to provide a deterrence output 336. For example, the alert manager 334 may cause one or more speakers on a surveillance unit to generate an audio alert an audio alert from the mobile surveillance unit including one or more of an alarm or verbal instructions from deterrence script. The audio alert may indicate that one or more proscribed actions are taking place at the site or a verbal talk-down message to the object(s) at the site to de-escalate actions, cease actions, leave the site, or the like. In some embodiments, the alert manager 334 may cause a communication device to transmit one or more electronic messages to a user device within a vicinity of the site indicating that one or more individuals are committing proscribed actions at the site (e.g., vandalizing property at the site, are fighting at the site, or the like). In some embodiments, the alert manager 334 generates multiple alerts, such as an audible announcement and/or multiple communications to multiple user devices.

In some embodiments, the characteristic recognition model 540 may be implemented in a generative AI model to determine the at least one characteristic of the object. Such as generative AI model may be configured (e.g., trained) to detect, determine, or otherwise identify the at least one characteristic from the video frames 503, set of images 505, the cropped portion(s) 509, or any other of the plurality of images.

The generative AI model may determine the at least one characteristic associated with the video frame(s) based on an analysis of the entire video frame(s) and based on a large number of features and attributes that the generative AI model has been trained to analyze. The generative AI model may use a much more robust framework (e.g., hardware such as servers) than the object action recognition model 330 (e.g., edge computing device) in determining whether and what characteristics are depicted within a given video frame. Where multiple objects are depicted within a given video frame, this does not impact the analysis of the generative AI model in a similar fashion as the object action recognition model 330 that selectively evaluates cropped portions that depict isolated depictions of detected objects because the generative AI model operates on servers of a cloud computing network or device as opposed to an edge computing device. The generative AI model may evaluate a large number of images, videos, or frames to categorize the video frame contents and determine whether or what characteristics are depicted within the images (e.g., video frames, cropped portions, videos), independent of how many persons or other objects are depicted therein. By limiting the amount of images transferred to the cloud computing device for determining object characteristics, the data charges associated with communicating and processing the images may be limited. For example, a metered network may be used to communicate or process the images from the surveillance unit to the cloud network, and reducing the amount of data transmitted and processed may reduce costs. Further, by offloading the analytical tasks with a higher computation load (e.g., characteristics detection) than other tasks (e.g., object identification and action detection), the latency of such higher computation load tasks may be lowered by performing such tasks on hardware equipped to provide higher computational processing speeds than the on-board components of the mobile surveillance unit (e.g., edge computing device or camera).

The generative AI model may produce an output indicating the characteristics detected within the video frames 503. In some embodiments, determining a clarity of the output (e.g., a confidence or probability of the output is compared against a threshold confidence or probability) is performed to determine whether the output of the generative AI model is sufficiently conclusive regarding the characteristics detected. In the event that the output is clear or otherwise non-ambiguous, the surveillance system provides the detected characteristics of the object to the alert manager 334 for further action. As described above, responsive to receiving the determined characteristics (and determined action), the alert manager 334 may cause one or more of tracking the object with the at least one camera, providing a deterrence output from the mobile surveillance unit, or notifying a command center or GUI in communication with the mobile surveillance unit of the at least one characteristic. The deterrence may include any of the audio or light deterrence disclosed herein.

Alternatively, where the generative AI model output is not conclusive (e.g., where a probability score or a confidence score of the generative AI model output is less than a threshold metric), the surveillance system provides an indication to the object manager 328 to continue processing the incoming video frame(s). In such embodiments, based on the output of the generative AI model being inconclusive, the object manager 328 generates a cropped portion 509 of the video frame(s). The cropped portion(s) 509 of the video frame(s) is provided to one or both of the characteristic identifier 331 or the characteristic recognition model 540, the latter of which generates an output prediction indicating whether, and the type of, at least one characteristic is depicted within a given video frame. This output prediction may be provided to the alert manager 334 for further action as described herein.

The results of any portions of the algorithm 500 may be communicated to and displayed on the GUI 570. The GUI 570 may be accessible to a user, a customer, or an administrator. The GUI may include a user interface depicted in a web-based, device-based, application-based, or local computer based display. Accordingly, the user, customer, or administrator may be apprised of the information from the algorithm such as object(s) detected, actions detected, or characteristics of the object detected (e.g., list of characteristics).

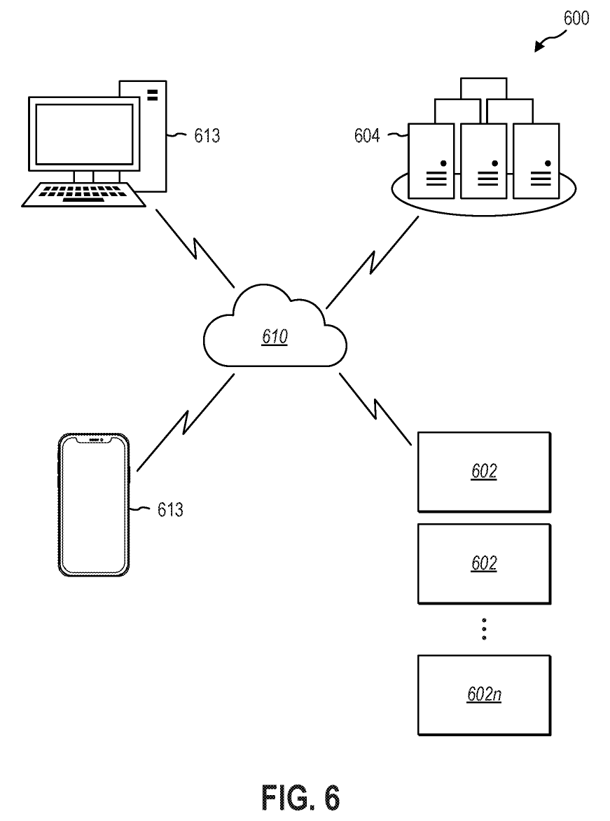

Any of the algorithms, workflows, or methods disclosed herein may be implemented in any of the systems or surveillance units disclosed herein. In some embodiments, the systems may include multiple mobile surveillance units. FIG. 6 is a schematic diagram of a system 600 for surveillance, according to at least one embodiment. System 600 includes at least one mobile surveillance unit 602, a server 604, and one or more remote devices 613. The at least one mobile unit 602 may be similar or identical to the mobile surveillance unit 101 or 202 (FIGS. 1 and 2) in one or more aspects. The at least one mobile surveillance unit 602 may include a plurality of mobile surveillance units 602. The at least one mobile surveillance unit 602 may include 1 to 10 mobile surveillance units, 1 to 5, 5 to 10, 2 to 5, 2 to 10, 20 or fewer, 10 or fewer, 5 or fewer, at least 4, or at least 2 mobile surveillance units 602. The server 604 may include a cloud server or any other server disclosed herein, such as the server 116. The remote device(s) 613 may include any of the remote devices disclosed herein, such as remote devices 113 (FIG. 1). The remote device(s) 613 may include an electronic device, such as a front-end device (e.g., a user device (e.g., mobile phone, tablet, etc.), a desktop computer, or any other suitable electronic device (e.g., including a display)). According to various embodiments, each of server 604 and remote device(s) 613 may be remote from mobile unit 602.

In some embodiments, the at least one mobile surveillance unit(s) 602, which may include a modem, may be within a first location (a “camera location” or a “remote location”), and server 604 may be within a second location, remote from the camera location. In such embodiments, remote device(s) 613 may be remote from the camera location and/or server 604. In some embodiments, at least one of the remote device(s) 613 may be at the camera location and/or server 604. The system 600 may be modular, expandable, and/or scalable by including more or fewer mobile surveillance units 602.

At least some of the at least one mobile surveillance units 602, remote devices 613, and the server 604 may be in wireless communication with each other via a wireless connection 610. The wireless connection 610 may include one or more of an internet service provider connection, the internet, a Wi-Fi connection, a cellular connection, a Bluetooth connection, or any other wireless data connection. Accordingly, the components of the system 600 may communicate with each other, such as for data transfers, alerts, GUI content updates, or the like.

The systems or components (e.g., mobile surveillance unit or heat unit) of the systems disclosed herein may be used to perform mobile surveillance including any of the tasks, acts, algorithms, workflows, or techniques disclosed herein. For example, any of the tasks, acts, algorithms, workflows, or techniques disclosed herein may be implemented as machine readable and executable instructions stored in the any of the systems or components disclosed herein.

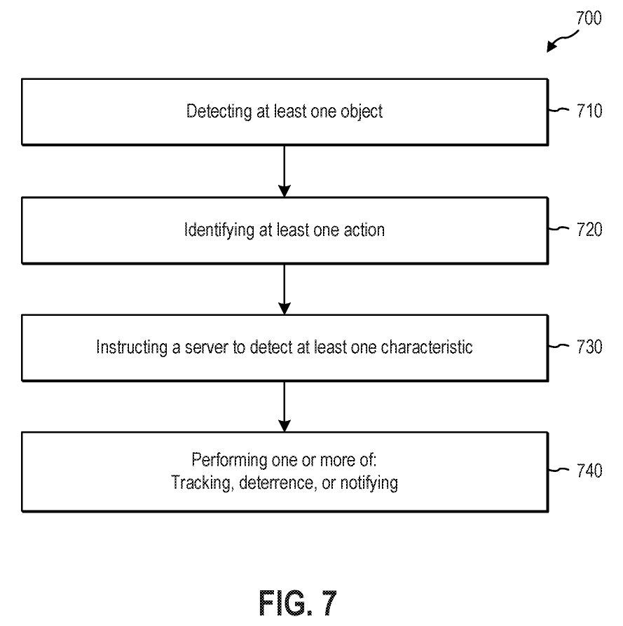

FIG. 7 is a flowchart of a method 700 for mobile surveillance, according to at least one embodiment. The method 700 includes an act 710 of detecting at last one object via at least one camera of a mobile surveillance unit, an act 720 of identifying at least one action associated with the at least one object via an edge device of the mobile surveillance unit; an act 730 of instructing a server operably coupled to the mobile surveillance unit via a metered connection to detect at least one characteristic associated with one or more of the at least one object or the at least one action and to communicate the at least one characteristic with the mobile surveillance unit; and an act 740 responsive to detecting the at least one characteristic, performing one or more of tracking the object with the at least one camera, providing a deterrence output from the mobile surveillance unit, or notifying a command center in communication with the mobile surveillance unit of the at least one characteristic. One or more portions of the method 700 may be performed by any of the devices, units, or systems disclosed herein, such as system 100 (FIG. 1), unit 202 (FIG. 4), system 600 (FIG. 6), or another device or system. In some embodiments, the method 700 may include more or fewer acts than the acts 710-740. For example, any of the acts 710-740 may be omitted, combined into a single act, split into multiple acts, or have additional acts added thereto.

Method 700 may begin at the act 710 of detecting at least one object via at least one camera of a mobile surveillance unit. The at least one object may be detected via at least one camera of a mobile unit. For example, the at least one object may be captured in one or more images (e.g., a video) by at least one camera on a head unit of a mobile surveillance unit. Detecting the at least one object may include processing one or more images with an object identifier such as any of the object identifiers disclosed herein. The object identifier may be implemented as software for analyzing one or more images of a field of view at a site of a mobile surveillance unit. The object identifier may be and the detecting the at least one object may be a portion of the software in the at least one camera. Detecting at least one object via at least one camera of a mobile surveillance unit may include obtaining image data including a plurality of images with the at least one camera, the plurality of images depicting at least a portion of a field of view of a site of the mobile surveillance unit and performing an object identification on the plurality of images.

The image data and plurality of images may include video, frames of video, time lapse images, photos, or any images of a field of view of the at least one camera. In some embodiments, the images may include thermal images, grayscale images, color images, or the like. The image data may include an electronic version of the plurality of images (e.g., MP4, AVI, MOV, Mjpeg, jpeg, or the like). The at least one object may include any of the objects disclosed herein, such as a human, an animal, an automobile, or the like.

Detecting at least one object via at least one camera of a mobile surveillance unit may include identifying an object in one or more images (e.g., video, video frames, cropped video frames) according to any of the algorithms or workflows disclosed herein. For example, detecting at least one object via at least one camera of a mobile surveillance unit may include using an input video manager, an object detector, an object tracker, or an object manager as disclosed herein to detect or identify an object.

The act 720 of identifying at least one action associated with the at least one object via an edge device of the mobile surveillance unit may include using any of the edge computing devices disclosed herein, such as a device including at least one processor and non-transitory memory storage medium containing machine readable and executable instructions that are executable by the at least one processor. The at least one action may include any of the actions or actions of interest disclosed herein, such as one or more of standing, walking, running, laying down, vandalism, rioting, unauthorized access to a site of the mobile surveillance unit, fighting, throwing, vandalism, or the like.

Identifying at least one action associated with the at least one object via an edge device of the mobile surveillance unit may include identifying the presence or absence of an action of interest (performed by the object). The action of interest may be input or noted as an action of interest in machine readable and executable instructions in the edge computing device. Identifying at least one action associated with the at least one object via an edge device of the mobile surveillance unit may include using any of the action identifiers or object action recognition models disclosed herein. The action identifiers or object action recognition models may be stored and implemented as machine readable and executable instructions stored, communicated to, or executed on the edge computing device.

Identifying at least one action associated with the at least one object via an edge device of the mobile surveillance unit may include performing an action identification on the at least one object in the plurality of images, such as in one or more cropped portions of the plurality of images. For example, identifying at least one action associated with the at least one object via an edge computing device of the mobile surveillance unit may include generating tracked samples of the plurality of images including cropped portions of the plurality of images, wherein the cropped portions include portions of the images containing the object and are associated with a tracking identifier corresponding to the at least one object that is depicted within the cropped portions of the plurality of images. The tracking identifier may be assigned or generated by an object manager as disclosed herein.

The act 730 of instructing a server operably coupled to the mobile surveillance unit via a metered connection to detect at least one characteristic associated with one or more of the at least one object or the at least one action and to communicate the at least one characteristic with the mobile surveillance unit may include detecting, identifying, or determining any of the characteristics of an object disclosed herein. For example, the at least one characteristic may include one or more of an item of clothing or accessory worn by the human (e.g., shirt, shorts, skirt, dress, coat, hat), a color of the clothing, spatial orientation of the human, identity of an object carried by the human (e.g., weapon, tool, case, box), skin color of the human, height of the human, weight of the human, gender or sex of the human, or the like.

Instructing a server operably coupled to the mobile surveillance unit via a metered connection may include transmitting one or more of the plurality of images (e.g., cropped frames), tracking identifiers (e.g., alpha numeric code for the image or object), or instructions for identifying the at least one characteristic to the servers of a cloud computing device. The metered connection may include a bit, byte, kilobyte, megabyte, gigabyte, etc. counter for counting the amount of data transmitted to the server(s) or processed on the server(s). The metered connection may be used to determine costs owed for services associated with the determinations on the servers.

In some embodiments, the servers may store instructions for detecting at least one characteristic associated with one or more of the at least one object or the at least one action responsive to receiving the at least one image.

Instructing a server operably coupled to the mobile surveillance unit via a metered connection to detect at least one characteristic associated with one or more of the at least one object or the at least one action and to communicate the at least one characteristic with the mobile surveillance unit may include sending at least some of the plurality of images to the server with instructions to apply a characteristic recognition model to the plurality of images to determine a characteristic prediction score associated with a prediction that a characteristic is depicted within the plurality of images, wherein the characteristic recognition model includes a multi-label classification model trained to generate an output prediction indicating whether the at least one characteristic is present within a given input image of the plurality of images.

In some embodiments, instructing a server operably coupled to the mobile surveillance unit via a metered connection to detect at least one characteristic associated with one or more of the at least one object or the at least one action and to communicate the at least one characteristic with the mobile surveillance unit may include providing an input prompt to a generative artificial intelligence (AI) model (e.g., stored on or accessed through the one or more servers) including instructions to identify the at least one characteristic within the plurality of images and communicate the at least one characteristic to one or more of the mobile surveillance unit or a graphical user interface in communication with the at least one server (e.g., on the remote device(s)). In such embodiments, providing an input prompt to a generative AI model including instructions to identify the at least one characteristic within the plurality of images and communicate the at least one characteristic to one or more of the mobile surveillance unit or a graphical user interface in communication with the at least one server may include sending the cropped portions of the plurality of images to the server(s) with instructions to apply a characteristic recognition model to the cropped portions to determine a characteristic prediction score associated with a prediction that a characteristic is depicted within the cropped portions, wherein the characteristic recognition model includes a multi-label classification model trained to generate an output prediction indicating whether the at least one characteristic is present within a given input image of the plurality of images as disclosed herein. The instructions may be sent by the edge computing device or may be stored in the one or more servers and are triggered to execute upon the receipt of the one or more images.

The act 740 of responsive to detecting the at least one characteristic, performing one or more of tracking the object with the at least one camera, providing a deterrence output from the mobile surveillance unit, or notifying a command center in communication with the mobile surveillance unit of the at least one characteristic. The act 740 may be directed by, or carried out at least in part by, an alert manager, the server(s), the edge computing device, or the at least one camera of a mobile surveillance system.

Tracking the object with the at least one camera may include capturing more images (e.g., video) of the object with one or more cameras on one or more mobile surveillance units. For example, tracking the object with the at least one camera may include tracking the object with the at least one camera, such as a plurality of cameras on a plurality of mobile surveillance units.

The deterrence output may include any of the deterrence outputs disclosed herein. For example, providing a deterrence output from the mobile surveillance may include one or more of tracking the object with a spotlight of the mobile surveillance unit, providing a visual indication of an alarm state (e.g., strobe or flashing lights), or providing an audio alert from the mobile surveillance unit including one or more of an alarm (e.g., siren) or verbal instructions from a deterrence script (e.g., talk down instructions, instructions to leave the site, or instructions to cease an activity, instructions that authorities have been notified). The deterrence may be provided by any of the output devices disclosed herein according to any of the techniques disclosed herein.

Notifying a command center in communication with the mobile surveillance unit of the at least one characteristic may include outputting the notification from the servers or the alarm manager. Notifying a command center in communication with the mobile surveillance unit of the at least one characteristic may include displaying on a GUI or causing a GUI to display one or more the at least one characteristic (e.g., list of characteristics), an image of the object, the action(s) of the object, any other aspects of the object identified in the one or more images, a live feed from the site, a live feed including video or images of the object (e.g., human) being tracked by the system, or the like.

In embodiments where cropped portions of the images are provided for action and character recognition, the act 740 may include causing the mobile surveillance unit to generate an alert associated with the object performing the at least one action at the site based on an indication from the server that the at least one characteristic is depicted within the cropped portions of the plurality of images. The alert may include any of the alerts disclosed herein.

In embodiments where a characteristic prediction score is provided by a characteristic recognition model or a generative AI trained to identify characteristics of the object or action, the act 740 includes causing the mobile surveillance unit to generate an alert associated with the object performing the at least one action at the site, based on the characteristic prediction score indicating that the characteristic is depicted within the plurality of images.

Modifications, additions, or omissions may be made to method 700 without departing from the scope of the present disclosure.

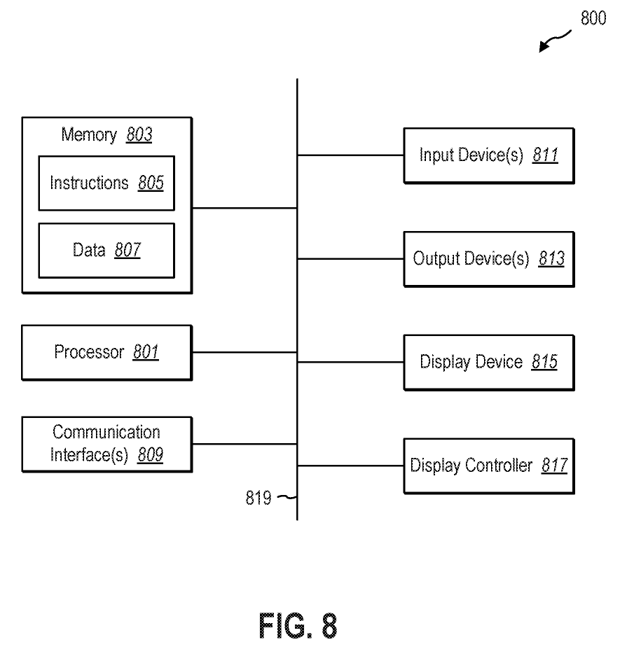

FIG. 8 is a block diagram of a computer system 800, according to at least one embodiment. FIG. 8 illustrates components that may be included within a computer system 800. One or more computer systems 800 may be used to implement the various devices, components, systems, and methods described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information, such as a non-transitory medium capable of being accessed and read by the processor 801. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

The memory may include (e.g., store) machine readable and executable instructions for performing one or more of any of the methods, algorithms, workflows, or techniques disclosed herein. For example, instructions 805 and data 807 may be stored in the memory 803. The instructions 805 may be executable by the processor 801 to implement some or all of the functionality disclosed herein. For example, any of the various examples of methods, algorithms, workflows, operations, or techniques described herein may be stored as instructions 805. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

The instructions 805, when read and executed by computer system 800, may cause computer system 800 to perform the acts or steps necessary to implement and/or use various embodiments of the disclosure. Programs or instructions may also be tangibly embodied in memory 803 and/or data communications devices, thereby making a computer program product or article of manufacture according to some embodiments. As such, the term “program” as used herein is intended to encompass a computer program accessible from any computer readable device or media. The program or instructions may exist on an electronic device (e.g., remote device 113, FIG. 1), a server (e.g., server 116, FIG. 1), a mobile unit (e.g., mobile unit 101 or 202, FIGS. 1 and 2), and/or another device or system. Furthermore, portions of the program or instructions may be distributed such that some of the program or instructions may be included on a computer readable media within an electronic device (e.g., edge computing device, remote device 113), some of the program or instructions may be included on a computer readable media on a server (e.g., server 116), some of the program or instructions may be included on a computer readable media on a surveillance unit (e.g., unit 101), and/or some of the program or instructions may be included on a computer readable media on another device. In some embodiments, the program or instructions may be configured to run on remote device 113, server 116, unit 101, another computing device, or any combination thereof. The program or instructions for any of the methods, algorithms, workflows, techniques, acts, or operations disclosed herein may exist on server 116 and/or unit 101 (e.g., in an edge computing device therein) and may be accessible to a user via remote device 113.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port, or the like. The computer system may be configured to communication with one or more of the cameras, edge computing devices, servers, or remote devices disclosed herein.

A computer system 800 may also include one or more input devices 811 and one or more output devices 813. Some examples of input devices 811 include a keyboard, mouse, microphone, remote control device, button, joystick, trackball, touchpad, and light pen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The computer system 800 may include or be implemented on one or more of a workstation; a laptop; an edge computing device; a hand-held device such as a cell phone, a tablet, or a personal digital assistant (PDA), a server, computer, or any other processor-based device. The computer system 800 may be operably coupled to a display (not shown in FIG. 8), which presents images to the user via a GUI. As will be appreciated, computer system 800 may include one or controllers including one or more operating systems, which may be configured and/or updated in accordance with various embodiments disclosed herein.

Generally, computer system 800 may operate under control of an operating system stored in memory 803, and interface with a user to accept inputs and commands and to present outputs through a GUI module. The instructions performing the GUI functions may be resident or distributed in the operating system, a program, or implemented with special purpose memory and processors in the computer system 800. The computer system 800 may also implement a compiler that allows a program (e.g., code) written in a programming language to be translated into processor readable and executable code or instructions. After completion, the program may access and manipulate data stored in memory 803 using the relationships and logic that are generated using compiler.

In some embodiments, the methods disclosed herein may be performed according to machine readable and executable instructions. Such instructions may be stored in a non-transitory computer readable medium, such as a disc, flash drive, a memory device (e.g., RAM, hard drive, solid state memory), or the like. Such instructions may be stored in a single device or system, or may be decentralized among more than one device or system.

In some embodiments, the non-transitory computer readable storage medium storing instructions thereon that, when executed by at least one processor, causes a computing device to obtain a plurality of images depicting at least a portion of a field of view at a site of a mobile surveillance unit. The instructions include instructions to detect at least one object in the field of view in the plurality of images via at least one image capture device. The instructions include instructions to identify at least one action associated with the at least one object via an edge computing device. The instructions include instructions to instruct a server operably coupled to the mobile surveillance unit via a metered connection to detect at least one characteristic associated with one or more of the at least one object or the at least one action and to communicate the at least one characteristic with the one or more processors. The instructions include instructions to, responsive to detecting the at least one characteristic, perform one or more of tracking the object with the at least one image capture device, providing a deterrence output from the mobile surveillance unit, or notifying a command center in communication with the one or more processors of the at least one characteristic. The instructions may include instructions to perform any of the methods, algorithms, workflows, acts, or techniques disclosed herein.

The systems, methods, algorithms, workflows, acts, and techniques disclosed herein provide reduced energy usage (e.g., longer battery life) compared to systems and methods that process all data on a cloud server. Additionally, the systems, methods, algorithms, workflows, acts, and techniques disclosed herein provide lower latencies for detecting objects, identifying actions of the objects, and identifying characteristics of the objects by balancing the local analysis of lower computational workload tasks (e.g., object detection and action identification) with remote analysis (e.g., cloud computing) of higher computational workload tasks (e.g., characteristics detection) off loaded from the unit(s) to the servers of a cloud computing network. The latency of the characteristic(s) detection performed on the remote servers may be reduced by retaining the object detection and action identification tasks in the mobile surveillance unit. Data transfer fees and processing costs are also lowered by retaining the object detection and action identification tasks in the mobile surveillance unit.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

In accordance with common practice, the various features illustrated in the drawings may not be drawn to scale. The illustrations presented in the disclosure are not meant to be actual views of any particular apparatus (e.g., circuit, device, system, etc.) or method but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A method for mobile surveillance, the method comprising:
detecting at least one object via at least one camera of a mobile surveillance unit;
identifying at least one action associated with the at least one object via an edge device of the mobile surveillance unit;
instructing a server operably coupled to the mobile surveillance unit via a metered connection to detect at least one characteristic associated with one or more of the at least one object or the at least one action and to communicate the at least one characteristic with the mobile surveillance unit; and
responsive to detecting the at least one characteristic, performing one or more of tracking the at least one object with the at least one camera, providing a deterrence output from the mobile surveillance unit, or notifying a command center in communication with the mobile surveillance unit of the at least one characteristic.

2. The method of claim 1, wherein detecting at least one object via at least one camera of a mobile surveillance unit includes:
obtaining image data including a plurality of images with the at least one camera, the plurality of images depicting at least a portion of a field of view of a site of the mobile surveillance unit; and
performing an object identification on the plurality of images.

3. The method of claim 2, wherein identifying at least one action associated with the at least one object via an edge device of the mobile surveillance unit includes performing an action identification on the at least one object in the plurality of images.

4. The method of claim 3, wherein instructing a server operably coupled to the mobile surveillance unit via a metered connection to detect at least one characteristic associated with one or more of the at least one object or the at least one action and to communicate the at least one characteristic with the mobile surveillance unit includes sending at least some of the plurality of images to the server with instructions to apply a characteristic recognition model to the plurality of images to determine a characteristic prediction score associated with a prediction that a characteristic is depicted within the plurality of images, wherein the characteristic recognition model includes a multi-label classification model trained to generate an output prediction indicating whether the at least one characteristic is present within a given input image of the plurality of images.

5. The method of claim 4, wherein the at least one object includes a human and the at least one characteristic includes one or more of an item of clothing worn by the human, a color of the clothing, spatial orientation of the human, identity of an object carried by the human, presence of a weapon carried by the human, skin color of the human, height of the human, or gender of the human.

6. The method of claim 4, further comprising, based on the characteristic prediction score indicating that the characteristic is depicted within the plurality of images, causing the mobile surveillance unit to generate an alert associated with the at least one object performing the at least one action at the site.

7. The method of claim 1, wherein providing a deterrence output from the mobile surveillance unit includes one or more of tracking the at least one object with a spotlight of the mobile surveillance unit, providing a visual indication of an alarm state, or providing an audio alert from the mobile surveillance unit including one or more of an alarm or verbal instructions from deterrence script.

8. The method of claim 1, wherein the at least one object includes a human and the at least one action includes one or more of standing, walking, running, laying down, vandalism, unauthorized access to a site of the mobile surveillance unit, or fighting.

9. The method of claim 8, wherein the at least one characteristic includes one or more of an item of clothing worn by the human, a color of the item of clothing worn by the human, an accessory worn by the human, or an object carried by the human.

10. The method of claim 1, wherein:
detecting at least one object via at least one camera of a mobile surveillance unit includes obtaining a plurality of images depicting the at least one object in at least a portion of a field of view of a site of the mobile surveillance unit;
identifying at least one action associated with the at least one object via an edge computing device of the mobile surveillance unit includes generating tracked samples of the plurality of images including cropped portions of the plurality of images, wherein the cropped portions are associated with a tracking identifier corresponding to the at least one object that is depicted within the cropped portions of the plurality of images; and
instructing a server operably coupled to the mobile surveillance unit via a metered connection to detect at least one characteristic associated with one or more of the at least one object or the at least one action and to communicate the at least one characteristic with the mobile surveillance unit includes providing an input prompt to a generative artificial intelligence (AI) model including instructions to identify the at least one characteristic within the plurality of images and communicate the at least one characteristic to one or more of the mobile surveillance unit or a graphical user interface in communication with the server.

11. The method of claim 10, further comprising generating cropped portions of the plurality of images including the at least one object therein, wherein the cropped portions are associated with a tracking identifier of the at least one object that is depicted within the cropped portions;
wherein providing an input prompt to a generative AI model including instructions to identify the at least one characteristic within the plurality of images and communicate the at least one characteristic to one or more of the mobile surveillance unit or a graphical user interface in communication with the server includes sending the cropped portions to the server with instructions to apply a characteristic recognition model to the cropped portions to determine a characteristic prediction score associated with a prediction that a characteristic is depicted within the cropped portions, wherein the characteristic recognition model includes a multi-label classification model trained to generate an output prediction indicating whether the at least one characteristic is present within a given input image of the plurality of images.

12. The method of claim 10, further comprising, based on an indication from the server that the at least one characteristic is depicted within the cropped portions of the plurality of images, causing the mobile surveillance unit to generate an alert associated with the at least one object performing the at least one action at the site.

13. A system for mobile surveillance, the system comprising:
a mobile surveillance unit including at least one image capture device and an edge computing device;
one or more processors;
memory in electronic communication with the one or more processors; and
instructions stored in the memory, the instructions being executable by the one or more processors to:
capture, by the at least one image capture device, a plurality of images depicting at least a portion of a field of view at a site of the mobile surveillance unit;
detect at least one object in the field of view via the at least one image capture device;
identify at least one action associated with the at least one object via the one or more processors associated with the edge computing device;
instruct a server operably coupled to the mobile surveillance unit via a metered connection to detect at least one characteristic associated with one or more of the at least one object or the at least one action and to communicate the at least one characteristic with the one or more processors; and
responsive to detecting the at least one characteristic, perform one or more of tracking the at least one object with the at least one image capture device, providing a deterrence output from the mobile surveillance unit, or notifying a command center in communication with the one or more processors of the at least one characteristic.

14. The system of claim 13, wherein the mobile surveillance unit includes:
a portable trailer;
a head unit including the at least one image capture device and the edge computing device; and
a mast connected to and extending upward from the portable trailer, the mast supporting the head unit at an upper region of the mast.

15. The system of claim 13, wherein:
the at least one image capture device is configured to perform object detection on the plurality of images and convey the plurality of images and presence of the at least one object therein to the edge computing device;
the edge computing device is configured to perform action detection on the at least one object in the plurality of images and convey a determined action and the plurality of images to a server; and
the server is configured to perform characteristic detection on the at least one object in the plurality of images and convey one or more detected characteristics to the one or more processors.

16. The system of claim 15, wherein one or more of the at least one image capture device, the edge computing device, or the server is coupled to at least one artificial intelligence (AI) model configured to perform the object detection, the action detection, or the characteristic detection.

17. The system of claim 15, wherein the server includes a cloud server.

18. The system of claim 13, wherein the at least one object includes a human and the at least one characteristic includes one or more of an item of clothing worn by the human, a color of the clothing, spatial orientation of the human, identity of an object carried by the human, presence of a weapon carried by the human, skin color of the human, height of the human, or gender of the human.

19. The system of claim 13, wherein the instructions stored in the memory further include instructions being executable by the one or more processors to:
generate cropped portions of the plurality of images, the cropped portions including the at least one object therein; and
instruct the server to detect at least one characteristic associated with one or more of the at least one object or the at least one action in the cropped portions and to communicate the at least one characteristic with the one or more processors.

20. A non-transitory computer readable storage medium storing instructions thereon that, when executed by at least one processor, causes a computing device to:
obtain a plurality of images depicting at least a portion of a field of view at a site of a mobile surveillance unit;
detect at least one object in the field of view in the plurality of images via at least one image capture device;
identify at least one action associated with the at least one object via an edge computing device;
instruct a server operably coupled to the mobile surveillance unit via a metered connection to detect at least one characteristic associated with one or more of the at least one object or the at least one action and to communicate the at least one characteristic with the at least one processor; and
responsive to detecting the at least one characteristic, perform one or more of tracking the at least one object with the at least one image capture device, providing a deterrence output from the mobile surveillance unit, or notifying a command center in communication with the at least one processor of the at least one characteristic.
